(19) United States
(12) Patent Application Publication
(10) Pub. No.: US 2021/0018118 A1
(43) Pub. Date: Jan. 21, 2021

(54) LONG FLEXIBLE TUBING ELEMENT (VARIANTS)

(71) Applicant: UCT TECHNOLOGIES LIMITED LIABILITY COMPANY [RU/RU], Moscow (JP)

(72) Inventor: Rivener Musavirovich GABDULLIN, Moscow (RU)

(73) Assignee: UCT TECHNOLOGIES LIMITED LIABILITY COMPANY [RU/RU], Moscow (RU)

(21) Appl. No.: 17/042,922

(22) PCT Filed: Jul. 15, 2019
(86) PCT No.: PCT/RU2019/000503

§ 371 Date: Sep. 29, 2020

(30) Foreign Application Priority Data
Aug. 6, 2018 (RU) 2018128527

(51) Int. Cl. F16L 11/22; F16L 11/04

(52) U.S. Cl. CPC F16L 11/22; F16L 11/042

(57) ABSTRACT

The invention relates to long-dimensional flexible tubes (coiled tubing). There are several variants of the proposed basic pairs of an umbilical coiled tubing and include means of their production with multi-stage sequential shaping process of one or multiple strips at an estimated geometry, and where isolated channels, partitions and flanges are formed during this process. If required, longitudinal butts of an additional shaped longitude strips can be welded to them to form additional hydraulic channels of the umbilical coiled tubing which can be reeled up to a drum. Other types of service channels (electric, fiber-optic, capillary etc.) or standard coiled tubing can be placed inside or outside channels in the form of a service channels tape. Flanges located beyond the outside dimensions of an umbilical coiled tubing may have a wave-type of form. Connecting partitions may have holes intended for fingers of injector, for elevator, for service channels tape. Flanges and partition holes are weight-carrying members of umbilical coiled tubing. Welding seams, flanges, centers of a closed channels and partitions are located, mainly, on the middle line of an umbilical coiled tubing's cross-section. The umbilical coiled tubing makes it possible to significantly increase possibilities of coiled tubing units in technological operations as well as in artificial lift methods due to its multi-channel design and, consequently, multifunctionality.

### FIELD OF THE INVENTION

The invention relates to long-dimensional flexible tubes (coiled tubing or lengthy flexible tubing), more specifically, reel spoolable coiled tubing.

### BACKGROUND

As practice of coiled tubing application in wells shows, it is reasonable to have multi-channel umbilical coiled tubing with various diameters, designs, and auxiliary service channels for implementation of many technological operations inside boreholes as well as reservoir fluid lifting using different artificiall lift methods.

A multi-channel umbilical coiled tubing is known comprising several hydraulic and electrical channels, which are (encapsulated) enclosed together in a single fused shell extruded from a polymer material with two flat surfaces for easy spooling. The extruded enclosure from polymeric material around the hydraulic and electrical channels forms a single multi-channel string in the shape of a long-dimensional flexible tape, which provides good protection for the hydraulic and electrical channels. Specific quantities and diameters of electric and hydraulic channels depend on whether electrical centrifugal submersible pump or hydraulic downhole pump is used. The hydraulic channels may comprise standard coiled tubing, standard plastic long-dimensional flexible pipes, or capillary tubes while electrical and information channels may comprise electrical wires or cables and fiber-optic lines (U.S. Pat. No. 8,459,965 issued Jun. 11, 2013).

One disadvantage of above-mentioned multi-channel umbilical coil tubing consists in increased weight of the multi-channel string due to deposited plastic. Another disadvantage is necessity to cut through the solid plastic enclosure in order to repair or replace a damaged electric line section (breakdown, earth fault, etc.) or fiber-optic or capillary line section (disrupted channel) followed by re-welding of plastic. In addition, deep and long scratches or abrasions on outer surface of plastic adversely affect the tightness of stripper (annular seal) and blowout preventer equipment.

A multi-channel coiled tubing is known comprising a set of service channels that matches to a desired well technology or lifting method. This multi-channel umbilical flexible tubing consists of two flexible long-dimensional service channels selected from the group comprising hydraulic lines, power electric cables, fiber-optic and electrically conductive information lines that are fused together with an elastic sheath to form a long string section. The string consists of two long sections in elastic shells with selected sets of service channels. To interconnect sections, at least one mating surface is made on the elastic shell of each long section parallel to string axis, one of mating surfaces having elongated locking slots and the other one having mating elongated locking protrusions that together ensure both connection of long sections into a multi-channel umbilical flexible tubing during tripping in hole and disconnection during tripping out of hole (Patent RU No. 2644366 issued Feb. 9, 2018).

One disadvantage of above-mentioned multi-channel coil tubing consists in increased weight of the multi-channel string due to deposited plastic. In addition, deep and long scratches or abrasions on outer surface of plastic adversely affect the tightness of stripper (annular seal) and blowout preventer equipment.

A multi-channel umbilical ArmorPak long flexible tubing and method of its assembly by installing permanent weld clamps on joints of standard flexible tubes (coil tubing) are known (www.cjstech.com). The multi-channel umbilical ArmorPak long coil tubing string is coiled off from the reel of coil tubing rig into a borehole to perform downhole operations or lifting of well fluid using, for example, submersible electric centrifugal pumps or hydraulic downhole pumps. If needed, additional standard flexible tubes (coil tubing) can be installed in the multi-channel umbilical long-dimensional ArmorPak flexible piping system either separately or inside desired channels.

Principal disadvantage of above mentioned configurable multi-channel umbilical flexible tubing is stepwise change in cross-section geometry of the string in the place of permanent weld clamps installation, which impairs integrity of the multi-channel umbilical coiled tubing system and its ability to pass through the stripper and blowout preventer. As a result, sealing ability of well equipment degrades and its service life decreases. The multi-channel umbilical flexible tubing also encounters technical difficulties in assembling a configuration with two or more service channels.

A multi-channel umbilical flexible tubing and method of its producing that includes placing one or few long-dimensional service channels, designed to deliver electrical energy, hydraulic energy, or fluids to a well and receiving borehole information on the surface, into a larger main coiled tubing, which is formed by wrapping a metal strip around the insulated service channel(s) and thereafter welding longitudinal edges of the metal strip (US Pat. No. 8,925,627 issued Jan. 6, 2015) is also known and may be considered as the closest prior art.

Disadvantages of the aforementioned multi-channel umbilical flexible tubing are related with increased weight, rigidity and cost of the string due to placing all channels inside the main outer large diameter coil tubing, which has to bear all the weight of multi-channel string when being suspended on injector head, thereby causing the necessity to increase wall thickness of the coil tubing and use steels of higher grades. Besides, a difficulty arises with suspension and sealing of free internal channels of the string in the wellhead. If the metal strip is used with a welded internal support (brackets), the multi-channel string becomes more expensive due to complicated manufacturing process and significantly more rigid at spooling on a reel owing the internal supports occupying the radial positions.

### SUMMARY OF THE INVENTION

Therefore, it is the first aim of the present invention to provide several embodiments of umbilical flexible tubing element, which can have various diameters, cross-sections, and/or configurations, composed from basic pairs of isolated channels that are produced from a single strip or several strips and have one or more flanges and/or partition plates, the umbilical flexible tubing element being intended for either independent application or assembling a long multi-channel umbilical flexible tubing based on the basic pairs and comprising additional welded long-dimensional flexible parts. The second aim of the present invention is to reduce tensile and compressive loads acting on the string tubing.

The aim of this invention is to produce, using a multi-stage shaping and welding, an element of umbilical flexible tubing based on basic pair of isolated channels with reinforced flanges and/or partition plates with reinforced weld seams, the weld seams, partition plates, and thick edges being arranged on the string cross-section midline to enable aligned spooling onto a standard drum. In addition, the aim of this invention is to reduce tensile and compressive loads acting on the string tubing due to the presence of hitches on flanges or partition plates of the string.

According to one embodiment of the invention, the stated problem is solved, and the stated aim is achieved, by manufacturing a basic pair of isolated channels, in an element of umbilical flexible tubing comprising at least two isolated channels integrated into a single structure, from two strips by separate shaping of each strip from center to form walls of two basic isolated channels while remaining free outward ends of longitudinal edges aligned in the same plane and subsequent welding of longitudinal edges of each strip with each other along contacting surfaces to form edge flanges, followed by final welding the longitudinal ends of the edge flanges of both channels with each other to form a connecting partition.

Also, according to another embodiment, the stated problem is solved, and the stated aim is achieved, by manufacturing a basic pair of isolated channels, in an element of umbilical flexible tubing comprising two isolated channels integrated into a single structure from two strips by separate shaping of each strip from a center of each strip, with the formation of a shaped flange in a form of a longitudinal fold with welded interior, followed by longitudinal shaping of remained strip parts to form walls of two basic isolated channels, while bringing out ends of longitudinal edges to outside, and followed by welding of the longitudinal edges to each other along their contacting surface with formation of edge flanges, followed by welding of the longitudinal ends of the edge flanges of both basic isolated channels with each other to form a connecting partition.

According to another embodiment, two more arch-shaped strips are welded from different sides to peripheral shaped flanges of the basic pair of isolated channels to form two additional isolated channels.

According to another embodiment, at least one shaped flange of the basic pair of isolated channels located outside the outer string dimensions has a wavy shape of alternating convexities and concavities.

According to another embodiment, the basic pair of isolated channels is formed from a single strip by shaping the strip from center to form a shaped flange in a form of a longitudinal fold with welded interior, and followed by shaping of strip parts to form walls of the first isolated channel and subsequent welding of joints of the walls to each other along contacting surfaces to form a connecting partition, followed by further shaping strip parts to form walls of the second basic isolated channel, and followed by welding of the longitudinal edges with each other along their contacting surfaces to form an edge flange.

According to another embodiment, edges of two more arch-shaped strips are welded from different sides to peripheral shaped flanges of the basic pair of isolated channels to form two additional isolated channels.

Also, according to another embodiment, each of the closed basic channels is formed from two strips by their separate shaping from centers with subsequent welding of contact points of walls of the basic isolated channels with each other to form a two-strip intermediate product with a connecting partition, and subsequent shaping of the intermediate product to form two basic isolated channels with ends of longitudinal edges brought out to outside and their subsequent welding along contacting surfaces to form two edge flanges, and wherein the connecting partition and two edge flanges are located on the same plane.

Also, according to another embodiment, the stated problem is solved, and the stated aim is achieved, by manufacturing each isolated channel of the basic pair, in an element of umbilical flexible tubing comprising two basic isolated channels integrated into a single structure, from two strips by separate shaping of each strip from centers of the strips to form longitudinal edges with ends brought out to outside, followed by welding of opposite longitudinal edges of the two strips to each other along their contacting plane to form two edge flanges and the basic isolated channel, the edge flanges being located diametrically opposite to each other, followed by welding longitudinal ends of the edge flanges with each other to form a connecting partition.

According to another embodiment, the edges of two more arch-shaped strips are welded from different sides to peripheral edge flanges of the basic pair of isolated channels to form two additional isolated channels.

According to another embodiment, at least one edge flange of the basic pair of isolated channels, which is located outside of outer dimensions of the tubing, has a shape of alternating crests and troughs.

According to another embodiment, the basic pair of isolated channels is formed from two strips by separate shaping of each strip from a center of the strip to form two walls of the basic isolated channels with ends of longitudinal edges brought out to outside, followed by subsequent welding the longitudinal edges to each other along their contacting surface to form edge flanges, aligning the basic pair of isolated basic channels in one plane in such manner that edge flanges are located opposite to each other, and followed by welding two more arch-shaped strips from different sides to the edge flanges to form two additional isolated channels.

### BRIEF DESCRIPTION OF THE DRAWINGS

The present summary is illustrated by the cross-sectional and side-view drawings of elements of long umbilical flexible tubing based on basic pairs of isolated channels. Welding operations are conducted along longitudinal lines of the strip, welding locations are indicated by bold arrows, the order of welding sequence is shown by bold Roman numerals, the welding seam on the cross-section is shown by a bold line.

FIG. 1 shows two separate isolated channels with edge flanges.

FIG. 2 shows basic pair of elements of a long two-channel umbilical flexible tubing with the connecting partition made of welded edge flanges of two isolated channels.

FIG. 3 shows an element of long two-channel umbilical flexible tubing with extended edge flange of isolated channel and the second welded isolated channel.

FIG. 4 shows two separate isolated channels with shaped and edge flanges.

FIG. 5 shows basic pair of isolated channels of a long two-channel umbilical flexible tubing element with the connecting partition made of welded edge flanges of two isolated channels.

FIG. 6 shows element of a long four-channel umbilical flexible tubing consisting of a basic pair of isolated channels with two welded arc-shaped strips.

FIG. 7 is a cross-sectional view of basic pair of isolated channels of a long two-channel umbilical flexible tubing element with the connecting partition made of welded edge flanges of two isolated channels and shaped wavy flanges on periphery.

FIG. 8 is a side view of basic pair of elements of a long coiled-tubing string with the connecting partition made of welded edge flanges of two isolated channels and shaped wavy flanges on periphery.

FIG. 9 shows the initial phase of manufacturing an isolated channel of a long two-channel umbilical flexible tubing element from one strip with shaped flange and connecting partition.

FIG. 10 shows the final phase of manufacturing a basic pair of isolated channels of a long two-channel umbilical flexible tubing element from a single strip with edge and shaped flanges on periphery and connecting partition.

FIG. 11 shows a single-strip basic pair of isolated channels connected by the connecting partition and having edge and shaped flanges on periphery with two welded arc-shaped strips.

FIG. 12 shows the initial phase of manufacturing a basic pair of isolated channels of a long two-channel umbilical flexible tubing element from two strips with a connecting partition.

FIG. 13 shows the final phase of manufacturing a basic pair of isolated channels of a long two-channel umbilical flexible tubing element from two strips with connecting partition and two edge flanges on periphery.

FIG. 14 shows basic pair of isolated channels of a long two-channel umbilical flexible tubing element made from two strips with perforated connecting partition, two edge flanges on periphery, and two elastic service tapes on different sides of the connecting partition.

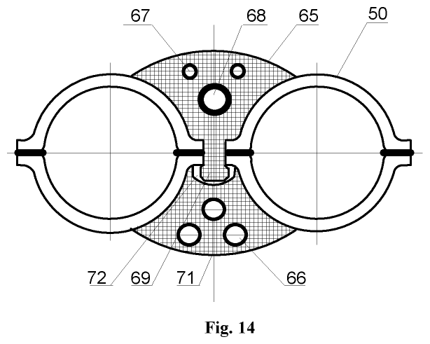

FIG. 15 shows two separate isolated channels made from two strips each, with two edge flanges on each.

FIG. 16 shows basic pair of isolated channels of a long two-channel umbilical flexible tubing element with connecting partition made of welded edge flanges of two two-strip isolated channels.

FIG. 17 shows element of a long four-channel umbilical flexible tubing consisting of a basic pair of isolated channels with two welded arc-shaped strips.

FIG. 18 is a transverse cross-sectional view of basic pair of isolated channels of a long two-channel umbilical flexible tubing element with connecting partition and edge flanges on periphery with a spline geometry in the form of alternating protrusions and recesses.

FIG. 19 is a side view of basic pair of isolated channels of a long two-channel umbilical flexible tubing element with connecting partition and edge flanges on periphery with a spline geometry in the form of alternating protrusions and recesses.

FIG. 20 shows two separate isolated channels with edge flanges arranged on periphery diametrically opposite to each other and two arch-shaped strips welded from different sides to the peripheral edge flanges.

### DETAILED DESCRIPTION OF THE INVENTION

An element of umbilical flexible tubing consists of a single or two shaped and specially welded together strips to form a basic pair of isolated channels with peripheral edge and/or shaped flanges, the basic pair of isolated channels may be applied either independently or as a part of multi-channel string produced using multiple successive stages of shaping and welding with attaching additional strips. Embodiments of basic pairs of isolated channels for the umbilical flexible tubing element and method of manufacturing thereof are presented below.

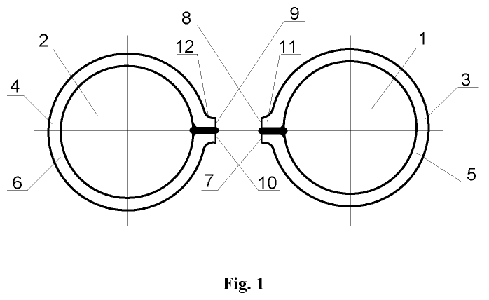

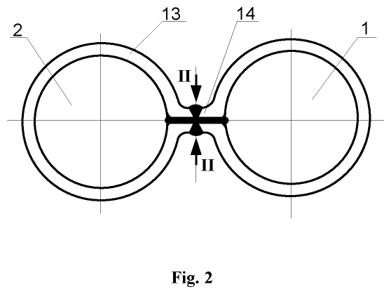

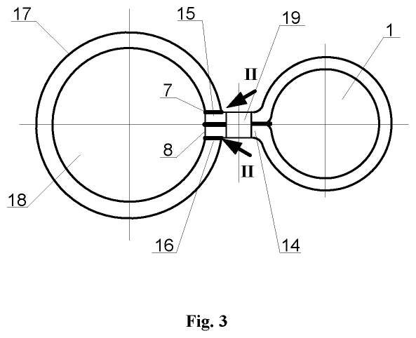

First embodiment of basic pair of isolated channels 1 and 2 for the umbilical flexible tubing element, as FIG. 1 shows, is manufactured by initial shaping two strips 3 and 4 by series of rollers from their centers to form walls 5 and 6 of isolated channels 1 and 2 with pairwise aligning ends 7 and 8 vs. 9 and 10 of the inverted longitudinal edges of strips 3 and 4 along two planes faced one against another from both sides of the central plane A-A, and subsequent welding of contacting surfaces of the ends 7 and 8 vs. 9 and 10 of inverted longitudinal edges with each other to form the basic pair of isolated channels 1 and 2 with edge flanges 11 and 12, respectively. Then ends of edge flanges 11 and 12 of isolated channels 1 and 2 are welded with each other to form the basic pair 10 of isolated channels 1 and 2 interconnected by a connecting partition 14 (FIG. 2). As a special case of above embodiment, a second isolated channel 18 (FIG. 3) of basic pair 10 can be formed by extending the welded contact surfaces of ends 7 and 8 of inverted longitudinal edges of the isolated channel 1 and subsequent welding of ends 15 and 16 of the second shaped strip 17 from different sides to the ends 7 and 8 of the inverted longitudinal edges of isolated channel 1. Diameters, wall thickness, and steel grade of both isolated channels may be the same or different. The connecting partition 14 has uniformly spaced holes 19 intended for fingers of injector head and to connect various flexible service channels.

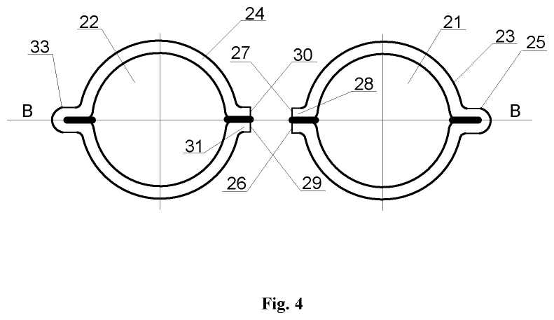

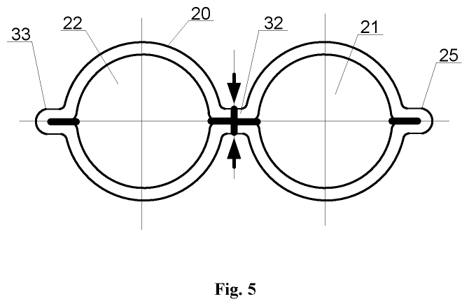

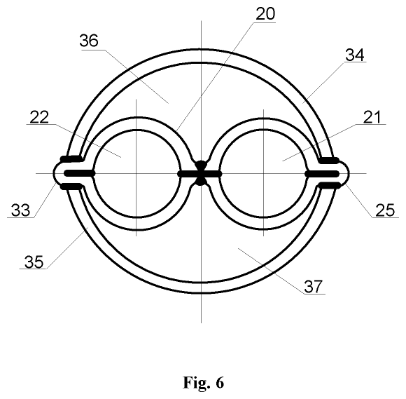

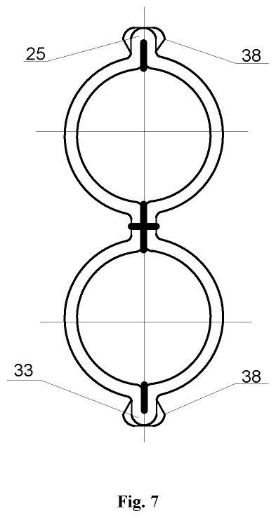

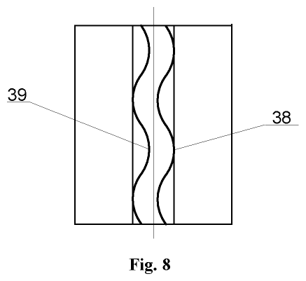

Second embodiment of basic pair 20 of isolated channels 21 and 22 for the umbilical flexible tubing element, as FIG. 4 shows, is manufactured by initial shaping two strips 23 and 24 by series of rollers from their centers to form shaped flanges 25 and 33 in the form of longitudinal folds with welded interior. Then lateral parts of strip 23 are shaped with facing ends 26 and 27 of inverted longitudinal edges of strip 23 one against another from both sides of the central plane B-B with subsequent welding contacting surfaces of the ends 26 and 27 of inverted longitudinal edges with each other to form the isolated channel 21 with edge flange 28. The lateral parts of another strip 24 are similarly shaped with facing ends 29 and 30 of inverted longitudinal edges of strip 24 one against another from both sides of the central plane B-B, and subsequent welding the contacting surfaces of the ends 29 and 30 of inverted longitudinal edges with each other to form basic isolated channel 22 with edge flange 31. Then ends of edge flanges 28 and 31 of isolated channels 21 and 22 are welded with each other to form the basic pair 20 of isolated channels 21 and 22 interconnected by a connecting partition 32 (FIG. 5). As a special case of the second embodiment, it is possible to manufacture a four-channel embodiment of long umbilical flexible tubing element (FIG. 6) due to forming two additional isolated channels 36 and 37 by welding edges of two more arch-shaped strips 34 and 35 from different sides to, respectively, peripheral shaped flanges 25 and 33 of the basic pair 20 of isolated channels 21 and 22. As an another special case of the second embodiment involving transfer most of string weight load onto the peripheral flanges of the basic pair of isolated channels outside the outer string dimensions, the flanges can have a wavy shape (FIGS. 7 and 8) with convexities 38 and concavities 39 for better gripping, holding and moving the long string with injector head or elevator.

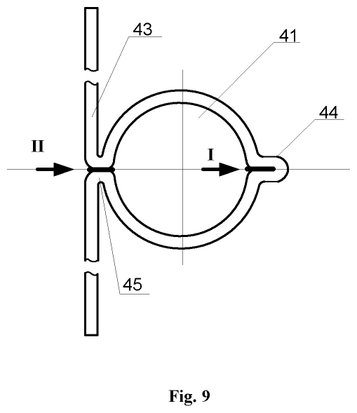

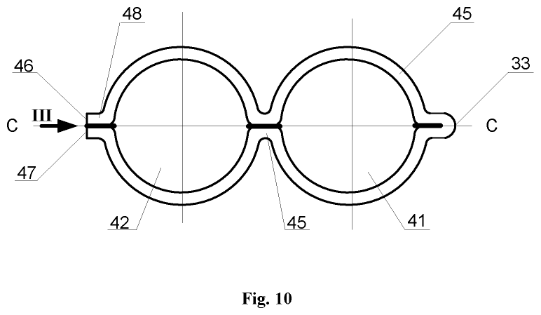

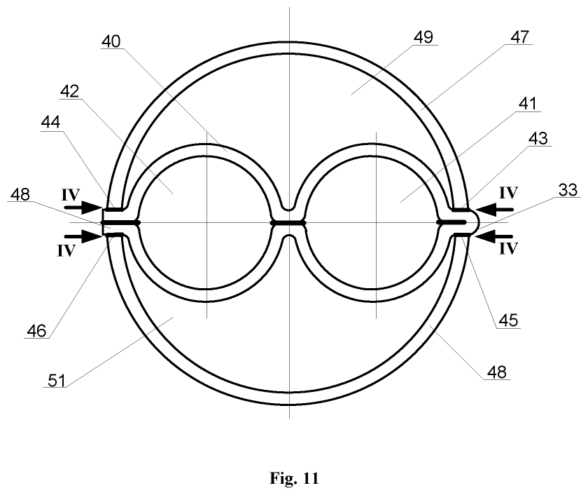

Third embodiment of basic pair 40 of isolated channels 41 and 42 for the umbilical flexible tubing element, as FIGS. 9 and 10 show, is manufactured by initial shaping a single strip 43 from center to form shaped flange 44 in the form of longitudinal fold with welded interior. Then the remaining parts of the strip 43 are shaped to form walls of the first isolated channel 41 with subsequent welding the channel 41 wall joints with each other along contacting surfaces to form a connecting partition 45 (FIG. 9). Thereafter, remaining parts of strip 43 are shaped with facing ends 46 and 47 of inverted longitudinal edges of strip 43 one against another from both sides of the central plane C-C, with subsequent welding the contacting surfaces of the ends 46 and 47 of inverted longitudinal edges with each other to form the isolated channel 42 with edge flange 48 (FIG. 10). As a special case of the third embodiment, it is possible to manufacture a four-channel embodiment of long umbilical flexible tubing element (FIG. 11) due to forming two additional isolated channels 49 and 51 by pairwise welding edges 43 and 44 vs. 45 and 46 of two more arch-shaped strips 47 and 48 from different sides to, respectively, shaped flange 33 and edge flange 48 of the basic pair 40 of isolated channels 41 and 42. As an another special case of the third embodiment involving transfer most of string weight load onto the peripheral flanges of the basic pair outside the outer string dimensions, the flanges can have a wavy shape (not shown) as in the previous case for better gripping, holding and moving the string.

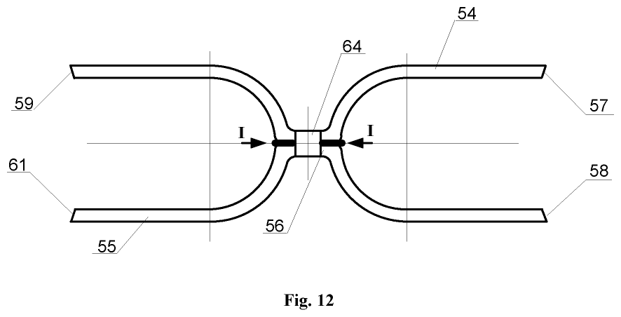

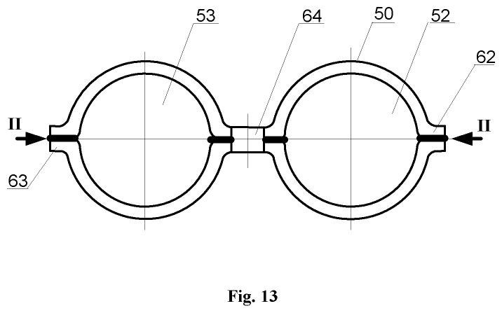

Fourth embodiment of basic pair 50 of isolated channels 52 and 53 for the umbilical flexible tubing element, as FIGS. 12 and 13 show, is manufactured by initial shaping two strips 54 and 55 by series of rollers from their centers with subsequent welding of strip joints with each other to form a two-strip semi-finished product with connecting partition 56 (FIG. 12), further shaping of the two-strip semi-finished product to form two basic isolated channels 52 and 53 with remaining free pairs of outward ends 57 and 58 vs. 59 and 61 of longitudinal edges, and final welding of these ends with each other along contacting surfaces to form two edge flanges 62 and 63 in such manner that the connecting partition 56 and both edge flanges 62 and 63 were aligned in the same plane (FIG. 13). The connecting partition 56 may have uniformly spaced holes 64 intended for fingers of injector head and elevator or to fix an externally placed elastic service tape 65 with electric 66, fiber-optic 67, and/or capillary 68 channels using fixing elements 69. The holes 64 have a specified geometry and spacing and serve as elements of a lock joint when combined with fixing elements 69, which can have shape of, for example, elastic knobs or mushrooms on the elastic service tape 65, or for better gripping by fingers of injector head. The material of protrusions may be elastic in the case of mushrooms or rigid in the case of collets. Spatial shape of mushroom-like protrusions may be conical, spherical, etc., while the head of protrusion may partially protrude to the opposite side of connecting partition 56 (in such cases opposite service tape 71 must have mating recesses 72 able to accommodate protruding fixing elements 69 of the first service tape 65) or be flush with the plate. The number of holes 64 may be twice the number of fixing elements 69, which allows to arrange a similar elastic service tape 71 on opposite side of the connecting partition 56 with one-hole offset in relation to the plate 56. The holes 64 and fixing elements 69 provide even distribution of elastic service tape 65 entire weight over the connecting partition 56, geometry of elastic service tape 65 and its position in depression between two isolated channels preventing any contacts of the service tape 65 with inner walls of the casing string, thereby eliminating need in strengthening or reinforcing of service tape 65, which enable to reduce weight of both service tape 65 and the multi-channel string as a whole. Besides, repair of power cables, fiber optic or capillary tubes becomes easier and simpler. Instead of flexible service tapes 65 and 71, standard coiled tubes and/or standard armored electrical cables fastened with clamps (not shown) may be placed in the space between isolated channels 52 and 53 and the connecting partition 56, which can allow single tubing separate production using various lift methods.

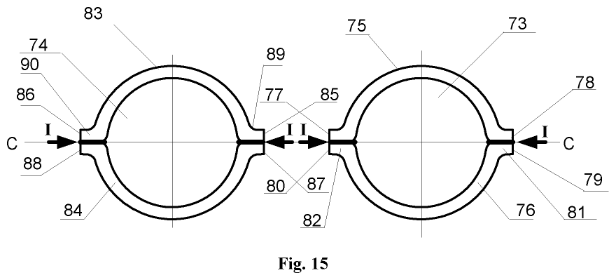

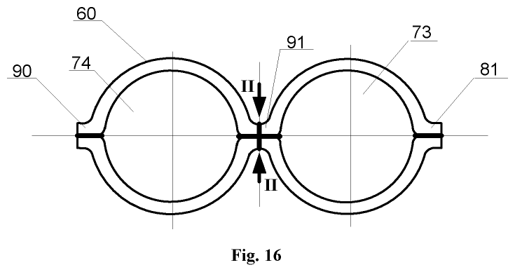

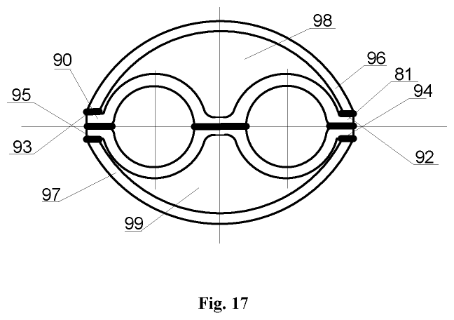

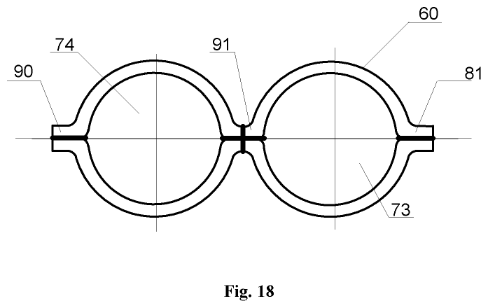

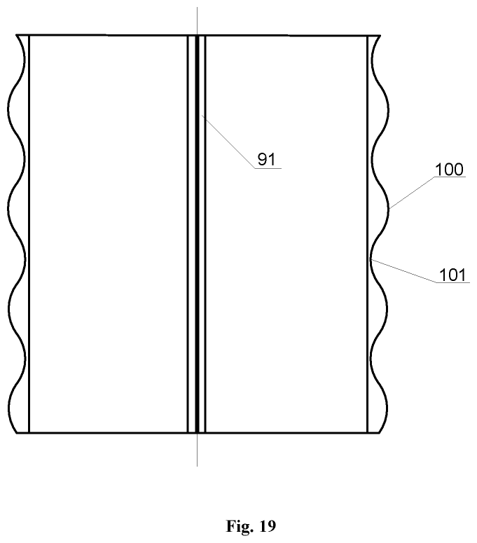

Fifth embodiment of basic pair 60 of isolated channels 73 and 74 for the umbilical flexible tubing element, as FIG. 15 shows, is manufactured by initial separate shaping of each strip 75 or 76 by series of rollers from its center to form longitudinal edges with remaining free outward ends 77 and 78 vs. 79 and 80, subsequent welding of longitudinal edges of both strips with each other along contacting surface to form two edge flanges 81 and 82 and isolated channel 73. Edge flanges 81 and 82 are arranged diametrically opposite to each other. Similarly, each strip 83 or 84 undergoes to initial separate shaping by series of rollers from its center to form longitudinal edges with remaining free outward ends 85 and 86 vs. 87 and 88, and subsequent welding of longitudinal edges of both strips with each other along contacting surface to form two edge flanges 89 and 90 and isolated channel 74. Edge flanges 89 and 90 are arranged diametrically opposite to each other. Finally, longitudinal ends of the edge flanges 82 and 89 of both isolated channels 73 and 74 are welded with each other to form a connecting partition 91 (FIG. 16). As a special case of the fifth embodiment, it is possible to manufacture a four-channel embodiment of long umbilical flexible tubing element from a basic pair (FIG. 17) due to forming two additional isolated channels 98 and 99 by pairwise welding edges 92 and 93 vs. 94 and 95 of two more arch-shaped strips 96 and 97 from different sides to shaped flanges 81 and 90, respectively. As another special case of the fifth embodiment involving transfer most of string weight load onto the peripheral flanges, the edge flanges 81 and 90 of the basic pair 60 of isolated channels 73 and 74 outside the outer string dimensions can have a spline geometry (FIGS. 18 and 19) with alternating crests 100 and troughs 101 for better gripping, holding and moving the long umbilical flexible tubing using injector head or elevators.

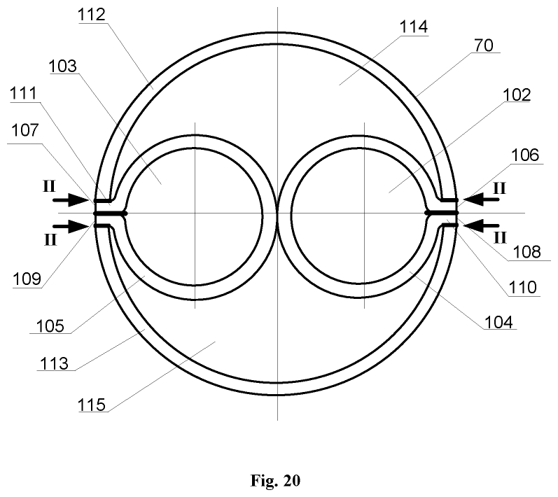

Sixth embodiment of basic pair 70 of separately produced isolated channels 102 and 103 for the umbilical flexible tubing element, as FIG. 20 shows, is manufactured by initial separate shaping of each strip 104 or 105 by series of rollers from its center to form longitudinal edges with pairs of remaining free outward ends 106 and 107 vs. 108 and 109 and subsequent welding of longitudinal edges with each other along contacting surface to form edge flanges 110 and 111. Then two basic isolated channels are aligned in the same plane in such manner that edge flanges 110 and 111 were arranged diametrically opposite to each other. Thereafter, outer walls of isolated channels 102 and 103 in the form of two more arch-shaped strips 112 and 113 are welded from different sides to peripheral shaped flanges 110 and 111 to form additional hydraulically connected channels 114 and 115. As a special case of the sixth embodiment involving transfer most of string weight load onto the peripheral flanges, the edge flanges 110 and 111 of the basic pair 70 of isolated channels 102 and 103 outside the outer string dimensions can have above-mentioned spline or wavy shape for better gripping, holding and moving the long umbilical flexible tubing using injector head or elevators. The main difference between crests, convexities and troughs, concavities are in the arrangement of the wave planes. The arrangement of convexities & concavities plane (wavy shape) is perpendicular to flange's plane. The arrangement of crests and troughs plane with spline geometry is parallel to flange's plane.

Availability of load-carrying spline or wavy flanges allows to significantly relieve walls of isolated channels from the string weight and transfer this load to the flanges and/or connecting partition, which, in turn, allows to apply steels of less expensive grades in the element of long umbilical flexible tubing as well as repair multi-channel long umbilical flexible tubing by cutting out defective lengths and welding inserts or patches in the field conditions. It should be noted that the availability of load-carrying spline or wavy flanges does not exclude the use of plane edge or shaped flanges as frictional load-bearing elements for injector tracks (gripper blocks).

All above embodiments of multi-channel elements of umbilical flexible tubing do not exclude all necessary processing procedures required to produce long flexible pipes (coiled tubing) such as edge machining, heating, sizing, etc. In addition, all proposed embodiments of umbilical flexible tubing element can be applied in both technological operations inside boreholes and fluid production facilities and setups.

All embodiments of multi-channel elements of umbilical flexible tubing are applicable as either conventional coil tubing or flexible lifting tubing with standard elevators but modified strippers, injector tracks (gripper blocks), guide archs, etc.

### INDUSTRIAL APPLICABILITY

The present invention makes it possible to significantly increase possibilities of coiled tubing units as well as the coiled tubing itself due to its multi-channel design and, consequently, multifunctionality.

1. An element of a lengthy umbilical flexible tubing, comprising two basic isolated channels integrated into a single structure, called a basic pair of isolated channels, wherein the basic pair of isolated channels is formed from two strips by separate shaping of each strip from a center of each strip to form walls of two basic isolated channels with ends of longitudinal edges brought out to outside and aligned in one plane, followed by welding of the longitudinal edges to each other along their contacting surface with formation of edge flanges, followed by welding of the longitudinal ends of the edge flanges of both channels with each other to form a connecting partition.

2-11. (canceled)

12. The element according to claim 1, wherein the basic pair of isolated channels is formed from two strips by separate shaping of each strip from a center of the strip to form two walls of the basic isolated channels with ends of longitudinal edges brought out to outside, followed by subsequent welding the longitudinal edges to each other along their contacting surface to form edge flanges, aligning the basic pair of isolated basic channels in one plane in such manner that edge flanges are located opposite to each other, and followed by welding two more arch-profiled strips from different sides to the edge flanges to form two additional isolated channels.

13. An element of a lengthy umbilical flexible tubing, comprising two basic isolated channels integrated into a single structure, called a basic pair of isolated channels, wherein the basic pair of isolated channels is formed from two strips by separate shaping of each strip from a center of each strip, with the formation of a shaped flange in a form of a longitudinal fold with welded interior, followed by longitudinal shaping of remained strip parts to form walls of two basic isolated channels, while bringing out ends of longitudinal edges to outside, and followed by welding of the longitudinal edges to each other along their contacting surface with formation of edge flanges, followed by welding of the longitudinal ends of the edge flanges of both basic isolated channels with each other to form a connecting partition.

14. The element according to claim 13, wherein edges of two additional arch-profiled strips are welded from different sides to peripheral shaped flanges of the basic pair of isolated channels to form two additional isolated channels.

15. The element according to claim 13, wherein at least one shaped flange of the basic pair of isolated channels, which is located outside of outer dimensions of the tubing, has a shape of alternating convexities and concavities.

16. The element according to claim 13, wherein the basic pair of isolated channels is formed from a single strip by shaping the strip from center to form a shaped flange in a form of a longitudinal fold with welded interior, and followed by shaping of strip parts to form walls of the first isolated channel and subsequent welding of joints of the walls to each other along contacting surfaces to form a connecting partition, followed by further shaping strip parts to form walls of the second basic isolated channel, and followed by welding of the longitudinal edges with each other along their contacting surfaces to form an edge flange.

17. The element according to claim 16, wherein edges of two additional arch-profiled strips are welded from different sides to peripheral edge and shaped flanges of the basic pair of isolated channels to form two additional isolated channels.

18. An element of a lengthy umbilical flexible tubing, comprising two basic isolated channels integrated into a single structure, called a basic pair of isolated channels, wherein each isolated channel of the basic pair is formed from two strips by separate shaping from centers of the strips to form longitudinal edges with ends brought out to outside, followed by welding of opposite longitudinal edges of the two strips to each other along their contacting plane to form two edge flanges and the basic isolated channel, the edge flanges being located diametrically opposite to each other, followed by welding longitudinal ends of the edge flanges with each other to form a connecting partition.

19. The element according to claim 18, wherein each of the closed basic channels is formed from two strips by their separate shaping from centers with subsequent welding of contact points of walls of the basic isolated channels with each other to form a two-strip intermediate product with a connecting partition, and subsequent shaping of the intermediate product to form two basic isolated channels with ends of longitudinal edges brought out to outside and their subsequent welding along contacting surfaces to form two edge flanges, and wherein the connecting partition and two edge flanges are located on the same plane.

20. The element according to claim 18, wherein edges of two additional arch-profiled strips are welded from different sides to the edge flanges of the basic pair of isolated channels to form two additional isolated channels.

21. The element according to claim 18, wherein at least one edge flange of the basic pair of isolated channels, which is located outside of outer dimensions of the tubing, has a shape of alternating crests and troughs.
